(19) United States
(12) Patent Application Publication
(10) Pub. No.: US 2016/0243935 A1
(43) Pub. Date: Aug. 25, 2016

(54) BEARING BRACKET

(71) Applicant: Hyundai Motor Company, Seoul (KR)

(72) Inventors: Jae-Hyung YUN, Hwaseong-si (KR); Hyoung-Jin YOON, Suwon-si (KR); Sung-Su YOO, Hwaseong-si (KR)

(73) Assignee: Hyundai Motor Company, Seoul (KR)

(21) Appl. No.: 14/935,900

(22) Filed: Nov. 9, 2015

(30) Foreign Application Priority Data
Feb. 24, 2015 (KR) 10-2015-0025814

(51) Int. Cl. B60K 17/24

(52) U.S. Cl. CPC B60K 17/24

(57) ABSTRACT

A bearing bracket which supports a drive shaft while allowing the drive shaft to be rotatable may include a first bracket which has a first head portion into which the drive shaft is fitted, and a first mounting portion which extends from one end of the first head portion and has an end fixed to a fixed body, and a second bracket which has a second head portion into which the drive shaft is fitted, and a second mounting portion which extends from one end of the second head portion and has an end fixed to the fixed body, in which the first head portion and the second head portion are coupled to each other so as to be in communication with each other so that the drive shaft penetrates the first head portion and the second head portion.

### CROSS-REFERENCE TO RELATED APPLICATIONS

The present application claims priority to Korean Patent Application No. 10-2015-25814, filed Feb. 24, 2015, the entire contents of which is incorporated herein for all purposes by this reference.

### BACKGROUND OF THE INVENTION

1. Field of the Invention

The present invention relates to a bearing bracket which is mounted to support a drive shaft that transmits rotational force from an engine to wheels, and more particularly, to a bearing bracket which is configured to support a drive shaft in a state in which a first bracket and a second bracket are coupled to be rotatable relative to each other, thereby further improving noise, vibration, and harshness (NVH) performance.

2. Description of Related Art

In the case of a front-wheel drive vehicle, rotational force produced by an engine is transmitted to driving wheels via the engine, a transmission, a drive shaft, a constant velocity joint, and an axle in sequence.

As illustrated in FIG. 1A and FIG. 1B, the drive shaft among the components has one end connected to the transmission and the other end connected to the axle to transmit rotational force, and the drive shaft is supported by a bearing bracket 2 that is fixedly mounted to a fixed body (a vehicle body, or a lower portion of a housing of the engine or the transmission).

The bearing bracket 2 in the related art has a structure in which a plate-shaped boss portion 4 is enlarged toward one side of a head portion 3 having a hole, and three bolt holes 5 are provided in the boss portion 4 such that the bearing bracket 2 is fixedly mounted to the fixed body by bolts. Further, a bearing, which supports a load of the drive shaft while allowing the drive shaft to be rotatable, is mounted on an inner circumferential surface of the hole in the head portion 3.

However, in the structure in the related art, since only one side of the head portion 3 is fixed by three-point fastening, a natural frequency is low (to the extent that a frequency of noise generated in the engine may cause resonance), and dynamic stiffness is low, and as a result, there is a problem in that vibration and noise occur.

That is, in the structure in the related art, since the bearing bracket is connected to the fixed body at only one point, there are problems in that NVH performance deteriorates and unbalance vibration is likely to occur in a misalignment situation that may occur when the bracket is assembled.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a bearing bracket capable of increasing a natural frequency and enhancing dynamic stiffness in order to prevent the occurrence of vibration in a vehicle body and resonance.

According to various aspects of the present invention, a bearing bracket which supports a drive shaft while allowing the drive shaft to be rotatable may include a first bracket which has a first head portion into which the drive shaft is fitted, and a first mounting portion which extends from one end of the first head portion and has an end fixed to a fixed body, and a second bracket which has a second head portion into which the drive shaft is fitted, and a second mounting portion which extends from one end of the second head portion and has an end fixed to the fixed body, in which the first head portion and the second head portion may be coupled to each other so as to be in communication with each other so that the drive shaft penetrates the first head portion and the second head portion.

The first mounting portion and the second mounting portion may be fixed to the fixed body in a state in which the first mounting portion and the second mounting portion are spread at a predetermined angle.

The first bracket and the second bracket may be detachably coupled to each other so as to be rotatable relative to each other.

A ring-shaped bearing may be mounted between the first head portion and the second head portion.

The first bracket and the second bracket may be made of aluminum (that is light in weight instead of cast iron in the related art).

According to the present invention having the aforementioned configuration, the bearing bracket is fastened to the fixed body at two points, thereby improving dynamic stiffness and a natural frequency.

Since fastening force is increased, aluminum may be used instead of cast iron, thereby reducing a weight of the bearing bracket. The first bracket and the second bracket may be detachably coupled to each other so as to be rotatable relative to each other, and then may be mounted on various fastening surfaces, thereby more flexibly coping with a misalignment situation that may occur when the bearing bracket is assembled.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A and FIG. 1B are views illustrating an appearance in which a drive shaft is fitted into a bearing bracket in the related art.

FIG. 2 is a perspective view of an exemplary bearing bracket according to the present invention.

FIG. 3 is a front view of the exemplary bearing bracket in FIG. 2.

FIG. 4 is a side view of the exemplary bearing bracket in FIG. 2.

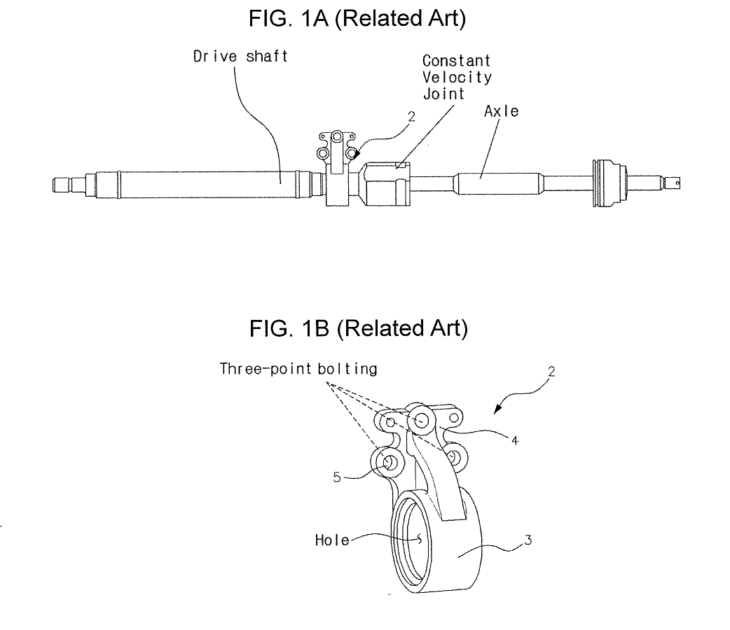

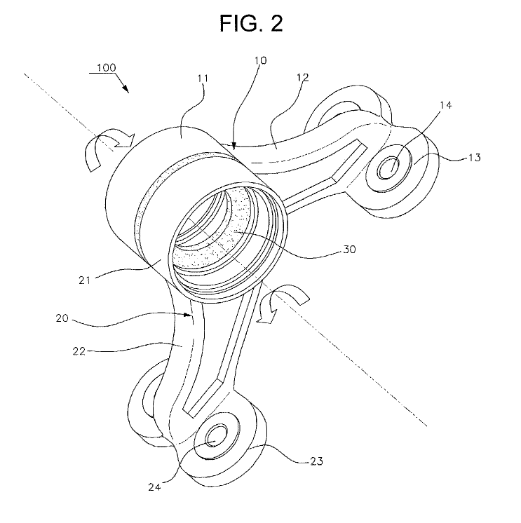

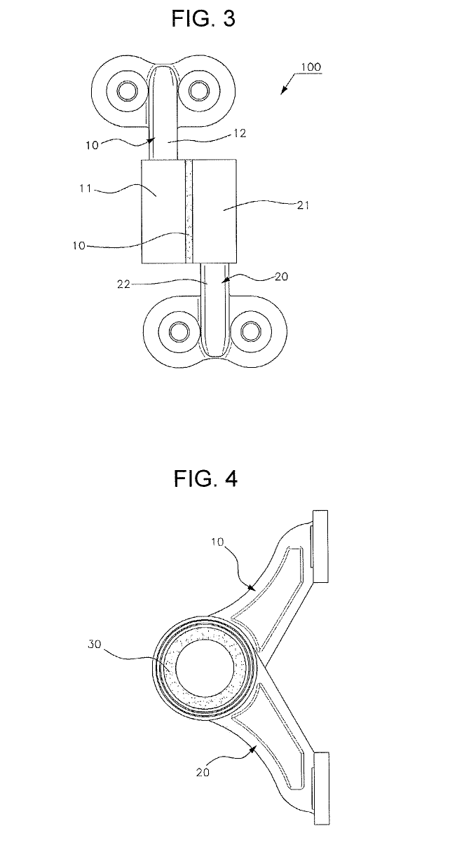

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention relates to a bearing bracket that is fastened, by bolting, to a fixed body such as a vehicle body, a housing of an engine, or a housing of a transmission, and supports a drive shaft while allowing the drive shaft to be rotatable. Hereinafter, various embodiments of the present invention will be described in more detail with reference to the drawings.

Referring to the drawings, a bearing bracket 100 of the present invention includes a first bracket 10 and a second bracket 20 that are detachably coupled to each other so as to be rotatable relative to each other.

The first bracket 10 includes a first head portion 11 into which a drive shaft is fitted, and a first mounting portion 12 which extends from one end of the first head portion 11 and has an end fixed to a fixed body, and a boss portion 13, which has bolt holes 14, is formed at an end of the first mounting portion 12.

The second bracket 20 has the same shape as the first bracket 10, or the second bracket 20 has a shape symmetrical to the shape of the first bracket 10. That is, the second bracket 20 includes a second head portion 21 into which the drive shaft is fitted, and a second mounting portion 22 which extends from one end of the second head portion 21 and has an end fixed to the fixed body, and a boss portion 23, which has bolt holes 24, is formed at an end of the second mounting portion 22.

The first head portion 11 and the second head portion 21 are coupled to each other so as to be in communication with each other so that the drive shaft may penetrate the first head portion 11 and the second head portion 21, and the first mounting portion 12 and the second mounting portion 22 are fastened to the fixed body by bolting in a state in which the first mounting portion 12 and the second mounting portion 22 are spread at a predetermined angle.

A ring-shaped bearing 30, which supports the drive shaft while allowing the drive shaft to be rotatable, is mounted between the first head portion 11 and the second head portion 21.

The first head portion 11 and the second head portion 21, which are disposed at both sides of the bearing 30, respectively, are detachably coupled to each other so as to be rotatable relative to each other in a direction indicated by the arrow in FIG. 2 (that is, clockwise and counterclockwise).

The first bracket 10 and the second bracket 20 according to the present invention may be made of, but not limited to, aluminum, which is light in weight, instead of cast iron in the related art.

That is, the number of fastening points at which the bracket is fixed by bolting is increased from one to two such that stiffness of the bracket is increased, and as a result, even though aluminum, which has a relatively low stiffness but is light in weight, is adopted, required dynamic stiffness may be sufficiently satisfied.

Therefore, according to the bearing bracket 100 according to the present invention, the first bracket 10 and the second bracket 20 are fastened at two points, upper and lower points of the fixed body, respectively, such that it is possible to improve dynamic stiffness and a natural frequency, and to mount the bracket on various fastening surfaces with waviness. In addition, the bearing bracket has a detachable structure, and as a result, it is possible to prevent misalignment that occurs in an assembling situation and any other situations, thereby further improving NVH performance.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A bearing bracket which supports a drive shaft while allowing the drive shaft to be rotatable, the bearing bracket comprising:
a first bracket which has a first head portion into which the drive shaft is fitted, and a first mounting portion which extends from one end of the first head portion and has an end fixed to a fixed body; and
a second bracket which has a second head portion into which the drive shaft is fitted, and a second mounting portion which extends from one end of the second head portion and has an end fixed to the fixed body,
wherein the first head portion and the second head portion are coupled to each other so as to be in communication with each other so that the drive shaft penetrates the first head portion and the second head portion.

2. The bearing bracket of claim 1, wherein the first mounting portion and the second mounting portion are fixed to the fixed body in a state in which the first mounting portion and the second mounting portion are spread at a predetermined angle.

3. The bearing bracket of claim 2, wherein the first bracket and the second bracket are detachably coupled to each other so as to be rotatable relative to each other.

4. The bearing bracket of claim 2, wherein a ring-shaped bearing is mounted between the first head portion and the second head portion.

5. The bearing bracket of claim 4, wherein the first bracket and the second bracket are detachably coupled to each other so as to be rotatable relative to each other.

6. The bearing bracket of claim 4, wherein the first bracket and the second bracket are made of aluminum.

7. The bearing bracket of claim 1, wherein the first bracket and the second bracket are detachably coupled to each other so as to be rotatable relative to each other.
